(19) United States
(12) Patent Application Publication
(10) Pub. No.: US 2002/0007458 A1
(43) Pub. Date: Jan. 17, 2002

(54) Communication apparatus

(76) Inventor: Yoshikatsu Ooi, Osaka (JP)

Correspondence Address: NIXON & VANDERHYE P.C., 8th Floor, 1100 North Glebe Road, Arlington, VA, 22201-4714, US

(21) Appl. No.: 09/901,024

(22) Filed: Jul. 10, 2001

(30) Foreign Application Priority Data
Jul. 11, 2000 (JP) P2000-209358
Jul. 19, 2000 (JP) P2000-218181
Jul. 19, 2000 (JP) P2000-218183

(51) Int. Cl. H04L 12/22

(52) U.S. Cl. 713/200; 709/229

(57) ABSTRACT

An object of the invention is to prevent unnecessary fetching of data stored in a server while preventing the occurrence of a situation in which no mail can be received at a necessary time in a communication apparatus for fetching the data stored in the server. In this communication apparatus, a time table number corresponding to a day of the week counted by a timer is obtained from a day of the week designated day storage section. An automatic calling time closest to and later than the present time is obtained from a calling time storage section and is set to a designated time based on this obtained time table number and the present time counted by the timer. Further, when the setting of designated time coincides with the present time counted by the timer, mail data destinated to own station stored in the server of an ISP is obtained by calling an access point of the ISP.

### BACKGROUND OF THE INVENTION

1. Field of the Invention

The present invention relates to a communication apparatus for fetching data stored in a server connected through a network.

2. Description of the Related Art

In recent years, an electronic mail system for transmitting and receiving mail data through the Internet is spread. When a general user utilizes this electronic mail (hereinafter called mail) system, it is necessary to connect a communication apparatus possessed by the user to an Internet service provider (hereafter called ISP) as an Internet connecting trader, and connect this communication apparatus to the Internet through a router managed by the ISP. The mail data transmitted and received through the Internet is temporarily stored in a server managed by the ISP. The mail data stored in the server managed by this ISP is normally fetched by the user's manual access to the server. However, an apparatus for automatically fetching the mail data is proposed in Japanese Unexamined Patent Publication JP-A 2000-138705 (2000), in which a time zone for accessing the server is preset, and access to the server is periodically carried out in the preset time zone.

However, when the mail data stored in the server is manually fetched as in the conventional apparatus, a problem exists in that there is a case in which the access to the server is delayed by operation forgetting of the user, or the like, and no mail can be received at a necessary time. In contrast to this, when the mail data stored in the server is automatically fetched, there is no case in which mail reception cannot be carried out when required. However, for example, when a working hours zone is set as a time zone of access to the server in a company, the server is accessed and the mail data stored in the server is fetched even when it is an off day (Saturday and Sunday) in the company or the user is out of the company. Therefore, a problem exists in that useless communication cost is taken and the fetched mail data stays on a communication apparatus side.

Further, it is necessary to manually predetermine a time interval of accessing the server to set the number of times that the server is accessed to a preset number in the preset time zone. Accordingly, a problem exists in that a complicated operation is required for the user.

### SUMMARY OF THE INVENTION

An object of the invention is to provide a communication apparatus for preventing unnecessary fetching of data stored in a server while preventing the occurrence of such a situation that no mail can be received when required.

To achieve the object, the invention provides a communication apparatus for accessing a server connected through a network and fetching data stored in the server, comprising: setting means for setting a time for accessing the server on the basis of inputted starting time data, terminating time data, and number of times data or time interval data; storage means for storing the time setting by the setting means on a weekly basis or daily basis; and control means for determining the time of accessing the server on the basis of setting data stored in the storage means and the present day of the week or date, and fetching data stored in the server by accessing the server at the determined time.

Accordingly, in accordance with the invention, the setting means-determines the time of accessing the server based on the inputted starting time data, terminating time data, and number of times data or time interval data. The determined time is stored in the storage means on a weekly basis or date basis. The control means determines the access time to the server based on setting data stored in the storage means and the present week day or date, and fetches data stored in the server by accessing the server at the determined time. Thus, the data can be fetched from the server in a different time zone every day.

As mentioned above, in accordance with the invention, the access time to the server is determined based on the inputted starting time data, terminating time data, and number of times data or time interval data. The determined time is stored on a weekly basis or date basis. The access time to the server is determined based on the stored setting data and the present day of the week or date, and data stored in the server is fetched by accessing the server at the determined time. Thus, the data can be fetched from the server in a different time zone every day. Therefore, it is possible to prevent unnecessary fetching of the data stored in the server while preventing the occurrence of a situation in which no mail can be received at a necessary time.

In addition to the above construction, the invention is constructed such that the storage means stores a time zone or date for inhibiting access to the server, and the control means makes no access to the server on the basis of the setting data stored in the storage means, in the access-inhibited time zone or date.

Accordingly, in accordance with the invention, the control means determines the access time to the server based on the basis of the setting data and the present day of the week or date stored in the storage means, and fetches data stored in the server by accessing the server at the determined time. Further, no access is made to the server based on the setting data stored in the storage means in the access-inhibited time zone or date. Thus, the data can be fetched from the server in a different time zone every day, and it is also possible to set the data so as not to be fetched from the server in a setting of time zone or date even in the time zone or date for fetching these data.

Further, in accordance with the invention, the access time to the server is determined based on the setting data stored in advance, to take out the data stored in the server by accessing the server at this determined time. The server is not accessed based on the setting data stored in the storage means in the access-inhibited time zone. Thus, it is possible to set the data so as not to be fetched from the server in a setting of time zone even in the time zone for fetching the data. Therefore, it is possible to prevent unnecessary fetching of the data stored in the server while preventing the occurrence of a situation in which no mail can be received at a necessary time.

In the invention, it is preferable that the storage means sets and stores the access time on a day of the week basis or date basis for plural servers, and the control means gets access based on the setting data stored in the storage means to each of the plural servers.

Accordingly, in accordance with the invention, since the access time can be set on a day of the week basis or date basis for respective servers, it is possible to prevent useless access to servers by increasing the number of access times to servers whose data is frequently updated and reducing the number of access times to other servers which have small data updating frequency.

In the invention, it is preferable that the storage means sets and stores an access-inhibited time zone or date for each of plural servers, and the control means accesses each of the plural servers according to the setting data stored in the storage means.

Accordingly, in accordance with the invention, access-inhibited time zones or dates can be set for respective servers. Therefore, it is possible to set a time zone in which a line of the server for performing communication is in a busy state, or a stopping period of the communication of the server for respective servers. Thus, each server can be set so as not to be accessed in this time zone or this period. Accordingly, useless access to each server can be prevented.

The invention provides a communication apparatus for accessing a server connected through a network and fetching data stored in the server comprising: setting means for determining an access time to the server based on inputted starting time data, terminating time data, and number of times data or time interval data; storage means for storing the time set by the setting means and a time zone for inhibiting access to the server; and control means for determining the access time to the server based on setting data stored in the storage means, and fetching data stored in the server by accessing the server at the determined time, and getting no access to the server on the basis of the setting data stored, in the storage means in the access-inhibited time zone.

Accordingly, in accordance with the invention, the control means determines the access time to the server based on the setting data stored in the storage means, and fetches data stored in the server by accessing the server at the determined time, and gets no access to the server on the basis of the setting data stored in the storage means, in the inhibiting time zone. Accordingly, the communication apparatus can be set such that no data is fetched from the server in a setting of time zone even in a time zone for fetching the data.

In the invention, it is preferable that the storage means stores the access time and the access-inhibited time zone for each of plural servers, and the control means determines the access time to each of the plural servers based on the setting data stored in the storage means.

Accordingly, in accordance with the invention, access is made to each of the servers based on the access time and the access-inhibited time zone, respectively. Thus, the access time can be individually set based on a data update time of each server. Further, a time zone for preventing access can be set in a time zone difficult or impossible to get access to each server. Thus, useless access to each server can be prevented.

The invention provides a communication apparatus for accessing a server connected through a network and fetching data stored in the server comprising: setting means for determining an access time to the server based on inputted starting time data, terminating time data and number of times data; storage means for storing the time determined by the setting means; and control means for accessing the server at the time stored in the storage means and fetching data stored in the server, wherein the setting means determines the time for accessing the server by avoiding any access-inhibited time zones to the server when the access-inhibited time zones have been inputted.

Accordingly, in accordance with the invention, the setting means determines the access time to the server based on the inputted starting time data, terminating time data and number of times data, and the storage means stores this determined time. The control means accesses the server at the time stored in the storage means and fetches data stored in the server. Thus, the number of access times to the server can be arbitrarily set in a setting of time zone without requiring a complicated operation of a user.

As mentioned above, in accordance with the invention, the access time to the server is determined based on the inputted starting time data, terminating time data and number of times data, and the server is accessed at this determined time and the data stored in the server is fetched. Thus, the number of access times to the server can be arbitrarily set in the setting of time zone without requiring the complicated operation of a user. Therefore, communication cost taken in access to the server can be restrained to an amount of fee that the user desires.

Further, in accordance with the invention, the setting means determines the access time to the server based on the inputted starting time data, terminating time data, number of times data and inhibited time zone data, and this determined time is stored in the storage means. The control means accesses the server at the time stored in the storage means and fetches data stored in the server. Thus, the number of access times to the server in a setting of time zone can be arbitrarily set, and the communication apparatus can be set such that no data is fetched from the server in an arbitrary time zone within this setting of time zone.

Further, in accordance with the invention, when a time zone for inhibiting access to the server is inputted, the time for accessing the server is determined by avoiding this time zone. Thus, the communication apparatus can be set such that no data is fetched from the server in an arbitrary time zone within the time zone for accessing the server. Therefore, the server can be accessed at an effective time based on the arbitrary setting of number of access times.

In the invention, it is preferable that the setting means determines the access time to each server by avoiding each inhibiting time zone inputted for each of the plural servers, and the control means accesses each of the plural servers based on the setting data stored in the storage means.

Accordingly, in accordance with the invention, an access-inhibited time can be determined for every individual server. Therefore, it is possible to set a time zone in which a line for performing communication is in a busy state for every individual server. Thus, each server can be set so as not to be accessed in this time zone of each server. Accordingly, useless access to each server can be prevented.

The invention provides a communication apparatus able to be connected to the Internet through a server connected through a public line network comprising: recalling means for repeating a connecting request to a desired calling destination when no connection to this calling destination can be performed; and setting means for individually setting a repeating interval of the connection request by the recalling means depending on when the desired calling destination is a server or not.

Accordingly, in accordance with the invention, the recalling means repeats the connecting request to the desired calling destination when no connection to this calling destination can be performed, and the setting means individually sets the repeating interval of this connection request depending on when the desired calling destination is a server or not. Accordingly, connection to the desired calling destination can be automatically performed without performing useless callings.

As mentioned above, in accordance with the invention, the connecting request to the desired calling destination is repeated when no connection to this calling destination can be performed, and the repeating interval of this connection request is individually set depending on the desired calling destination is a server or not. Accordingly, connection to the desired calling destination can be automatically performed without performing useless callings. Therefore, a reconnection request can be suitably made when the calling destination is busy.

In addition to the above construction, in the invention, it is preferable that the setting means sets the repeating interval of the connecting request by the recalling means for every individual server when plural connectable servers exist.

Accordingly, in accordance with the invention, the recalling means repeats the connecting request to the desired calling destination when no connection to this calling destination can be performed, and the setting means individually sets the repeating interval of this connection request depending on when a desired calling destination is a server or not. When the desired calling destination is a server, the repeating interval is set for every individual server. Thus, connection to the desired calling destination can be automatically performed without performing useless callings.

Further, in accordance with the invention, the connecting request to the desired calling destination is repeated when no connection to this calling destination can be performed, and the repeating interval of this connection request is individually set depending on when the desired calling destination is a server and is not a server. When the desired calling destination is a server, the repeating interval is set for every individual server. Thus, connection to the desired calling destination can be automatically performed without performing useless callings. Therefore, a reconnection request can be more suitably made when the calling destination is busy.

Further, the invention provides a communication apparatus able to be connected to the Internet through a server connected through a public line network comprising: automatic receiving means for fetching data stored in the server by periodically performing connection to the server; and recalling means for repeating a connection request to a desired calling destination when no connection to this calling destination can be performed, wherein in a repeating state of the connecting request to the desired calling destination, the recalling means stops the repetition of the connecting request to the desired calling destination being executed when the automatic receiving means is fetching the data.

Accordingly, in accordance with the invention, the recalling means repeats the connection request to the desired calling destination at the unconnectable time to this calling destination while in the repeating state of the connecting request to the desired calling destination, the recalling means stops the repetition of the connecting request to the desired calling destination being executed when the data is fetched by the automatic receiving means. Accordingly, connection to the desired calling destination can be automatically performed without obstructing periodic fetching of the data stored in the server.

Further, in accordance with the invention, the connection request to the desired calling destination is repeated at the unconnectable time to this calling destination, while in the repeating state of the connecting request to the desired calling destination, the repetition of the connecting request to the desired calling destination being executed is stopped when a periodic fetching time of the data has come. Accordingly, connection to the desired calling destination can be automatically performed without obstructing periodic fetching of the data stored in the server. Therefore, the periodic fetching of the data and a reconnection request to the calling destination in a busy state can be suitably made.

### BRIEF DESCRIPTION OF THE DRAWINGS

Other and further objects, features, and advantages of the invention will be more explicit from the following detailed description taken with reference to the drawings wherein:

FIG. 1 is a functional block diagram showing the construction of a facsimile apparatus in one embodiment of a communication apparatus of the invention;

FIG. 2 is an explanatory view showing the connection relation between the facsimile apparatus and other apparatuses;

FIG. 3 is a functional block diagram showing the construction of a main portion of this facsimile apparatus;

FIGS. 4A to 4D are explanatory views showing a table structure of time data, and day of the week and date data in this facsimile apparatus;

FIG. 5 is a flow chart showing operating control at an automatic receiving time in this facsimile apparatus;

FIGS. 6A to 6E are timing charts showing the timing of automatic reception in this facsimile apparatus;

FIG. 7 is a flow chart showing operating control at a time data setting time in this facsimile apparatus;

FIG. 8 is a functional block diagram showing the construction of a main portion of a facsimile apparatus in another embodiment; and

FIG. 9 is a flow chart showing operating control at a calling time in the facsimile apparatus in another embodiment.

### DETAILED DESCRIPTION OF THE PREFERRED EMBODIMENTS

Now referring to the drawings, preferred embodiments of the invention are described below.

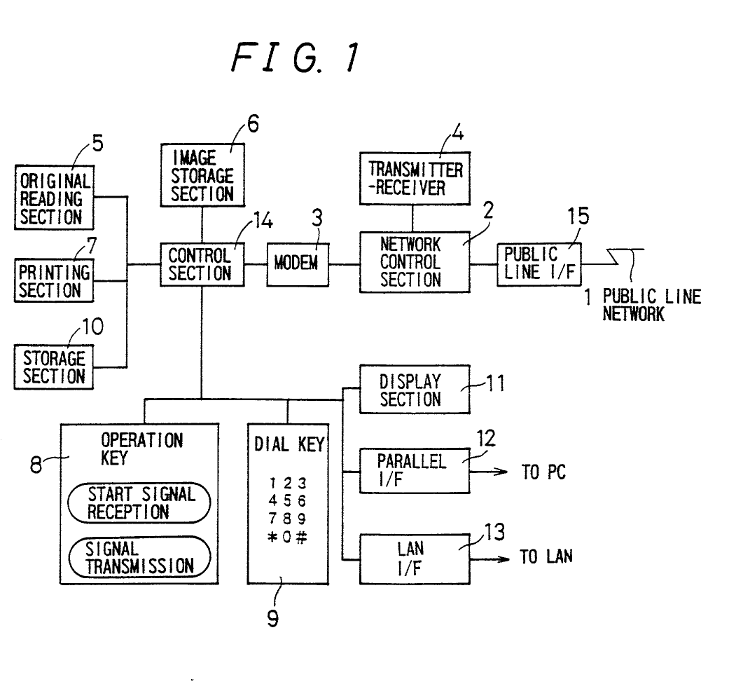

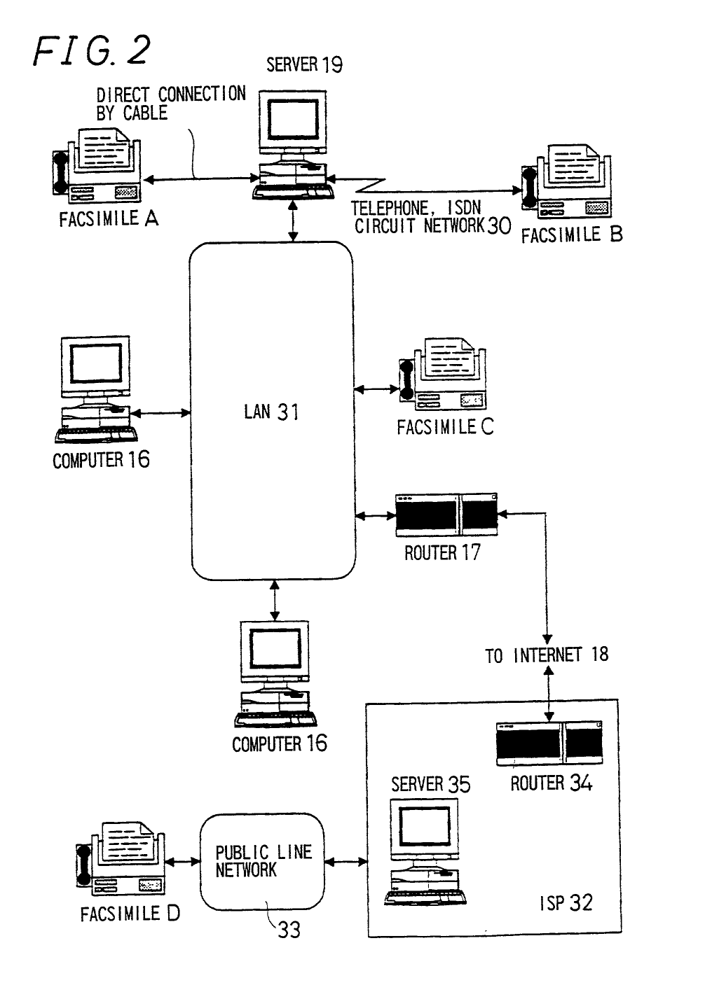

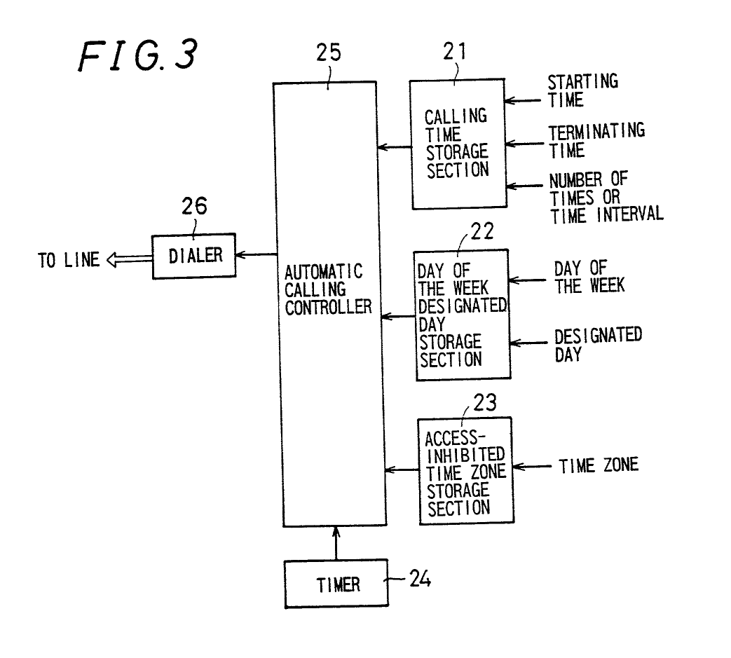

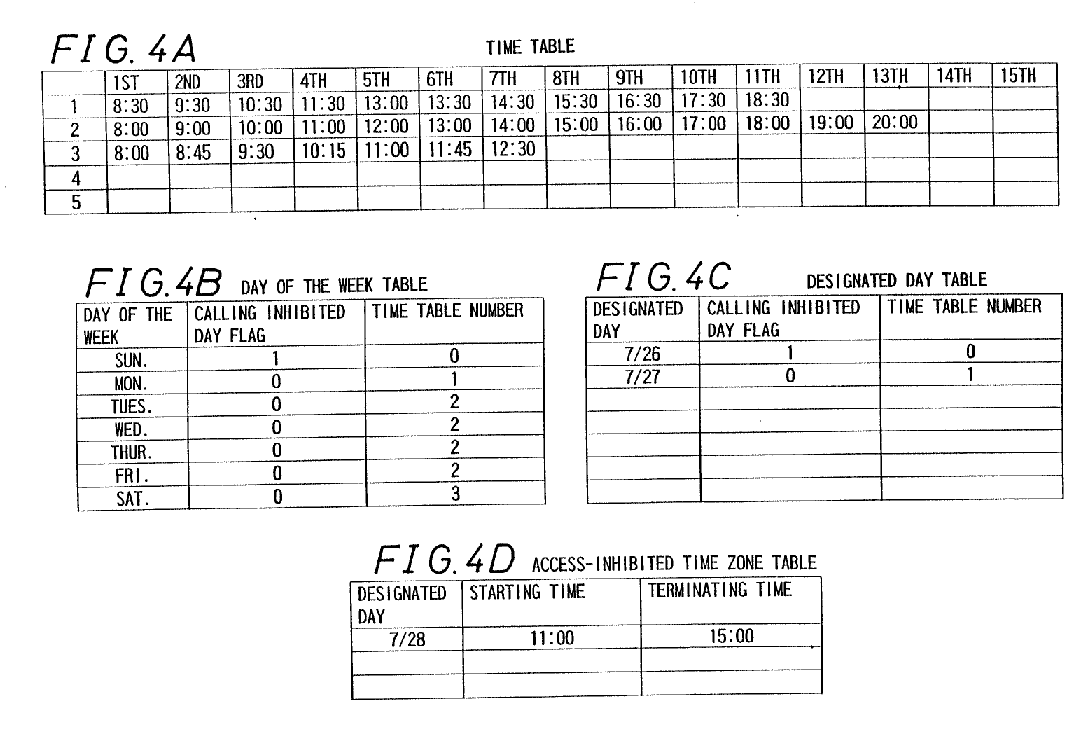

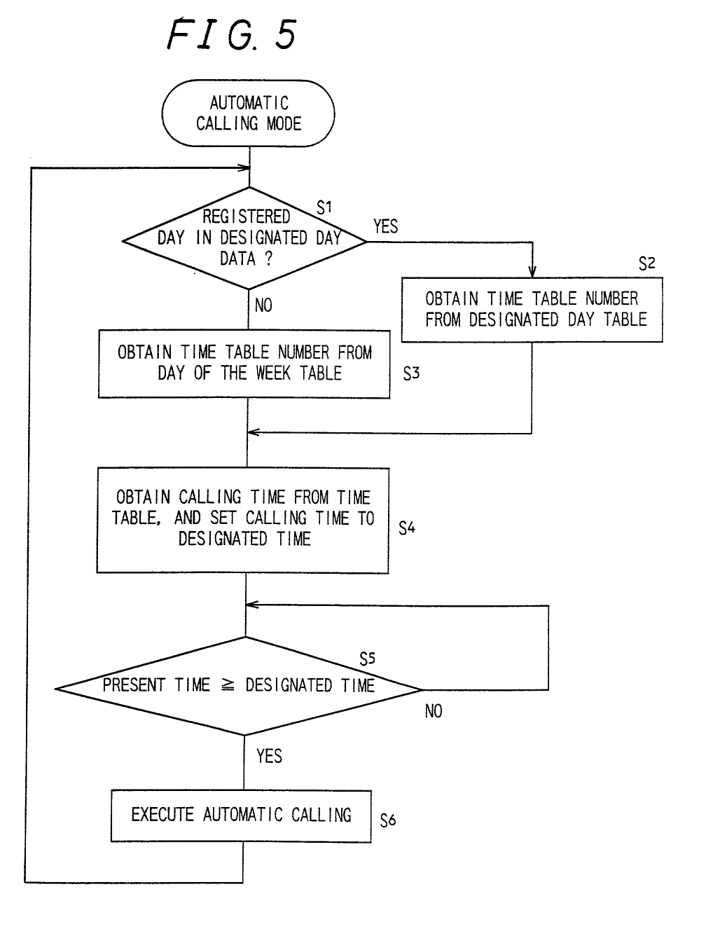

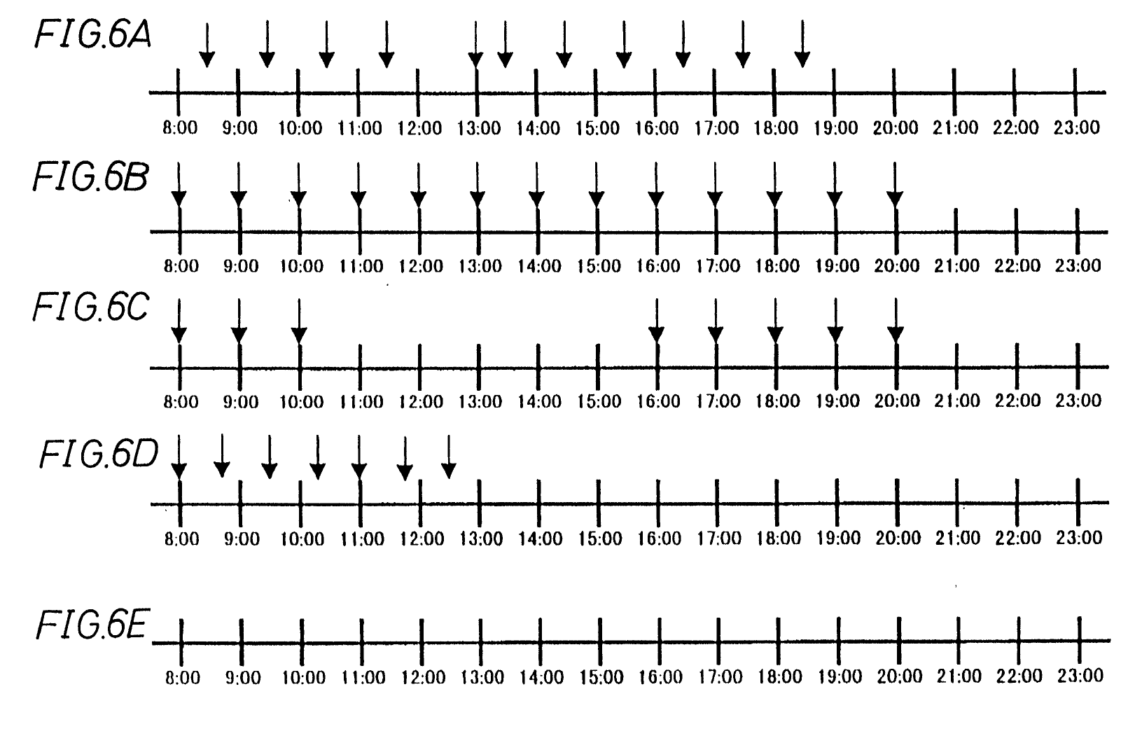

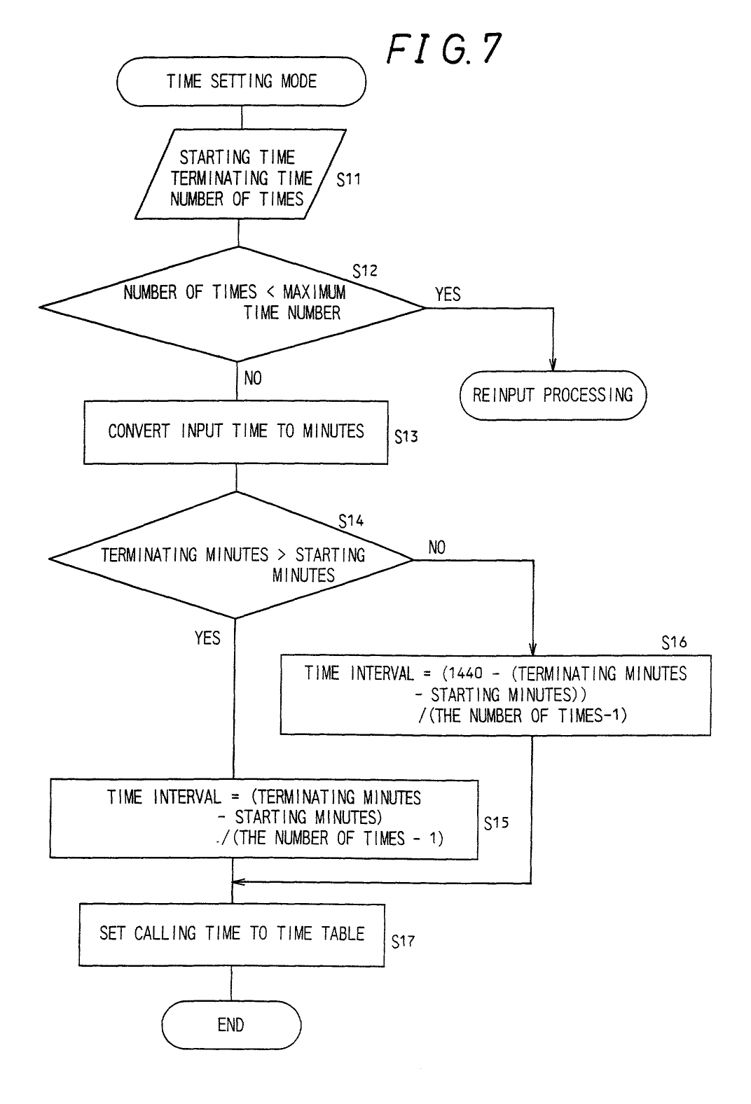

FIG. 1 is a functional block diagram showing the construction of a facsimile apparatus in one embodiment of a communication apparatus of the invention. FIG. 2 is an explanatory view showing the connection relation between the facsimile apparatus and other apparatuses. FIG. 3 is a functional block diagram showing the construction of a main portion of this facsimile apparatus. FIG. 4 is explanatory views showing a table structure of time data, and day of the week and date data in this facsimile apparatus. FIG. 5 is a flow chart showing operating control at an automatic signal receiving time in this facsimile apparatus. FIG. 6 is timing charts showing the timing of automatic signal reception in this facsimile apparatus. FIG. 7 is a flow chart showing operating control at the time of setting time data in this facsimile apparatus.

In FIG. 1, reference numerals 1, 2, 3 and 4 respectively denote a public line network, a network control section, a modem and a transmitter-receiver. The network control section 2 monitors the public line network 1 through an interface 15 for public line and switches a sending destination of a signal from the public line network 1 to sides of the modem 3 and the transmitter-receiver 4. The modem 3 modulates a digital signal of a read image to an analog signal suitable for the public line network 1, and demodulates the analog signal sent from the public line network 1 to a digital signal (image) for printing. The transmitter-receiver 4 collects a voice signal transmitted and received through the public line network 1, and emits a sound.

An image reading section 5 reads an image from an original, and uses a reduction reading system using a combination of a lens and a CCD (Charge Coupled Apparatus) line sensor, a close contact sensor system using a rod lens array, or the like.

An image storage section 6 stores the image demodulated by the modem 3 and the image read by the original reading section 5. This unit makes it possible to fulfill many complicated functions, e.g., transfer of a received image, multiple address, proxy reception at a paper running-out time, memory transmission.

A printing section 7 prints the image demodulated by the modem 3, the image read by the original reading section 5 and the image read from the image storage section 6 to a sheet of paper. A thermal system, an electrophotographic system, an ink jet system, or the like, are often used in the printing section 7.

Reference numerals 8, 9 and 10 respectively denote an operation key for designating start and stoppage of each of various kinds of functions, or the like, a dial key for inputting a telephone number, or the like, and a storage section for storing various kinds of data such as telephone directory data, a register table, or the like, a control program, or the like. Reference numerals 11, 12 and 13 respectively denote a display section for displaying various kinds of states of a apparatus main body, or the like, a parallel interface used in connection with a personal computer, and a LAN interface used in connection with LAN (Local Area Network).

A control section 14 gives commands to each section by determining an operation of the entire apparatus based on input information from the operation key 8 and the dial key 9, information showing a state from each section, signals from the public line network 1, the personal computer and the LAN, or the like, in cooperation with a program for control stored in the storage section 10. The control section 14 also performs compression processing for shortening a transmission time of image information, and extension processing for returning the compressed image information to original pixel series information. The facsimile apparatus is constructed so as to include the network control section 2, the modem 3, the transmitter-receiver 4, the original reading section 5, the image storage section 6, the printing section 7, the operation key 8, the dial key 9, the storage section 10, the display section 11, the parallel interface 12, the LAN interface 13 and the control section 14.

In the facsimile apparatus constructed as mentioned above, three kinds of interfaces are provided such as an interface 15 with the public line network 1, an interface 12 with the personal computer and an interface 13 with the LAN for performing communication with the Internet. However, the invention is not limited to these interfaces. Normal facsimile transmission and reception using the interface 15 with the public line network 1 may be performed, and communication with the Internet may be performed by one of the other interfaces. Otherwise, the normal facsimile transmission and reception and communication with a server computer of the LAN and the Internet may be also performed through the public line network 1. In other words, all communications may be also performed through the public line network 1. Namely, these three kinds of interfaces are leading connecting method with the Internet. However, it is not necessary to prepare all of these interfaces.

For example, there is a case in which normal facsimile data is received from another communication apparatus by the interface 15 with the public line network 1, and a server connected to a computer network is accessed by one of the interface 12 of another personal computer and the interface 13 with the LAN. There is also a case in which the normal facsimile data is received by another communication apparatus by the interface 15 with the public line network 1, and a server connected to the LAN or the Internet is accessed through the interface 15 with the public line network 1.

A connection example of the facsimile apparatus constructed as above will next be explained with reference to FIG. 2. FIG. 2 illustrates a method for performing Internet connection from a LAN network by using a corporate LAN often used for business, and a method for performing connection to the Internet through an ISP (Internet service provider) normally used when an individual performs connection to the Internet.

When the LAN is used, a computer 16 and the like as a terminal unit of a client are connected onto the LAN, and are also connected from the LAN 31 to the Internet 18 via a router 17. Further, communication data (test data, a facsimile image, a voice, or the like) to the client managed by a server computer 19 connected to this LAN 31 is temporarily stored in this server computer 19. This server computer 19 and the facsimile apparatus are directly connected through a cable as in a facsimile apparatus A, and are connected through a public line network such as a telephone-ISDN (Integrated Services Digital Network) line network 30, or the like, as in a facsimile apparatus B and are connected through the LAN 31 as in a facsimile apparatus C.

When the facsimile apparatus is directly connected to the server computer 19 by the cable as in the facsimile apparatus A and this facsimile apparatus A is used as a printer of the server computer 19, data is directly electrically sent and printed from a side of the server computer 19 when the server computer 19 receives mail. Conversely, image data is directly transmitted from the facsimile apparatus A to the server computer 19.

In contrast to this, when an individual performs connection to the Internet 18, a user normally makes a contract with the ISP 32, Internet connecting provider, and performs connection with the ISP through the public line network 33 such as the telephone-ISDN line network, so that connection to the Internet 18 is performed through a router 34 managed by the ISP. Thus, information of a client (facsimile apparatus D) transmitted and received through the Internet 18 is temporarily stored in the server computer 35 managed by the ISP.

Facsimiles A, B and C are connected to the server 19 which is connected to the LAN 31. The facsimile A is connected to the server computer 19 through the Interface 12 with the personal computer. The facsimile B is connected to the server computer 19 through the interface 15 with the telephone line 30. The facsimile C is connected to the server computer 19 through the LAN interface 13. A facsimile D connected to a server computer 35 managed by the ISP is connected through an interface with a telephone line 33.

An automatic receiving operation of the facsimile apparatus connected to the Internet as mentioned above will next be explained.

In FIG. 3, a calling time storage section 21 stores a time table in which a time for calling an access point of the ISP is set. As shown in FIG. 4A, plural times are set per time table number.

For example, the facsimile apparatus shown in FIG. 3 accesses the server computer 35 of the ISP through the public line network 33 as in the facsimile apparatus D shown in FIG. 2. The ISP has plural server computers, and the individual servers are arranged at individual access points.

Plural time table numbers are set in the time table, and one or plural calling times are set and stored per time table number.

A day of the week designated date storage section 22 stores a day of the week table which sets the relation of a day of the week, the time table number and a calling inhibited day, and a designated day table which sets the relation of a designated day, the time table number and the calling inhibited day. As shown in FIGS. 4B and 4C, the calling inhibited day and the time table number are set per day of the week and designated day.

In the day of the week table, it is set per a day of the week which time table number is used, and the calling inhibited day is further set. In the designated day table, it is set which time table number is used on a certain designated day, and one designated day for inhibiting calling is also set.

When the-time table number on the designated day set in the designated day table is different from the time table on the designated day stored in the day of the week day table on this designated day, the time table set in the designated day table is preferentially used.

An inhibited time zone storage section 23 stores a time zone for inhibiting calling to an access point of the ISP. As shown in FIG. 4D, the access-inhibited time zone is set per designated day.

The access-inhibited time zone storage section 23 stores an inhibited time zone table. In the access-inhibited time zone table, a designated day when calling is partially inhibited, and an inhibited time zone for the designated day are stored.

Reference numerals 24, 25 and 26 respectively denote a timer for counting the present time, an automatic calling controller and a dialer. The automatic calling controller 25 performs automatic calling in accordance with contents of the calling time storage section 21, the day of the week designated day storage section 22 and the inhibiting time zone storage section 23 using the time of the timer 24 as a reference. The dialer 26 sends dial data to the public line network 1 in accordance with instructions from the automatic calling controller 25.

Data set in each table is provided from a user by utilizing the dial key 9 and other interfaces. Accordingly, the user can set the access time zone, the number of access times, a time interval, an inhibited time zone, or the like, per server by utilizing the dial key 9 and the other interfaces.

The calling time storage section 21, the day of the week designated day storage section 22 and the accessin-hibited time zone storage section 23 are constructed so as to include the storage section 10. The timer 24 and the automatic calling controller 25 are constructed so as to include the storage section 10 and the control section 14. The dialer 26 is constructed so as to include the network control section 2. A calling operation is controlled by the calling time storage section 21, the day of the week designated day storage section 22, the access-inhibited time zone storage section 23, the timer 24, the automatic calling controller 25 and the dialer 26.

The control of the calling operation is started when it proceeds to an automatic calling mode based on operations of the operation key 8 and the dial key 9. First, it is judged whether a designated day conformed to the present date counted by the timer 24 is stored in the designated day storage section 22 or not (step S1). When the conformed designated day is stored in the day of the week designated day storage section 22, a time table number stored -in accordance with this designated day is obtained (step S2). In contrast to this, when no conformed designated day is stored in the designated day storage section 22, a time table number corresponding to the day of the week counted by the timer 24 is obtained from the day of the week designated day storage section 22 (step S3).

An automatic calling time closest to and later than the present time and not included in the access-inhibited time zone is obtained from the calling time storage section 21 to set it to a designated time, based on the obtained time table number, the present time counted by the timer 24, and the access-inhibited time zone stored in the access-inhibited time zone storage section 23 (step S4). When this setting of designated time and the present time counted by the timer 24 are conformed to each other (step S5), an access point of the ISP is called and mail data stored at a self station destination in the IPS servers are obtained (step S6). Thereafter, the above operation control (steps S1 to S6) is again executed.

Accordingly, for example, as shown in FIG. 4A, a calling time corresponding to a time table number “1” is set to “8:30/9:30/10:30/11:30/13:00/13:30/14:30/15:30/16:30/17:30/18:30”, and a calling time corresponding to a time table number “2” is set to “18:00/9:00/10:00/11:00/12:00/13:00/14:00 /15:00/16:00/17:00/18:00/19:00/20:00”, and a calling time corresponding to a time table number “3” is set to “8:00/8:45/9:30/10:15/11:00/11:45/12:30” as calling time data. Further, as shown in FIG. 4B, a calling inhibited day flag corresponding to Sunday is set to “1” and the time table number is set to “0”, and a calling inhibited day flag corresponding to Monday is set to “0” and the time table number is set to “1”, and a calling inhibited day flag corresponding to Tuesday is set to “0” and the time table number is set to “2”, and a calling inhibited day flag corresponding to Wednesday is set to “0” and the time table number is set to “2”, and a calling inhibiting day flag corresponding to Thursday is set to “0” and the time table number is set to “2”, and a calling inhibited day flag corresponding to Friday is set to “0” and the time table number is set to “2”, and a calling inhibited day flag corresponding to Saturday is set to “0” and the time table number is set to “3” as day of the week data. As shown in FIG. 4C, a calling inhibited day flag corresponding to July 26 is set to “1” and the time table number is set to “0”, and a calling inhibited day flag corresponding to July 27 is set to “0” and the time table number is set to “1” as designated day data. Further, as shown in FIG. 4D, an inhibited time zone corresponding to July 28 is set to “11:00 to 15:00” as inhibited time zone data. In such a setting state, when the control proceeds to the automatic calling mode during 8 on Monday in July 24 to 8 on Monday in July 31, an access point of the ISP is called and mail data stored in the ISP servers is taken at 8:30, 9:30, 10:30, 11:30, 13:00, 13:30, 14:30, 15:30, 16:30, 17:30 and 18:30 on Monday, July 24 and Thursday, July 27 as shown in FIG. 6A. The access point of the ISP is called and the mail data stored in the ISP servers is taken in at 8:00, 9:00, 10:00, 11:00, 12:00, 13:00, 14:00, 15:00, 16:00, 17:00, 18:00, 19:00 and 20:00 on Tuesday, July 25 as shown in FIG. 6B. The access point of the ISP is called and the mail data stored in the ISP servers is taken at 8:00, 9:00, 10:00, 16:00, 17:00, 18:00, 19:00 and 20:00 on Friday, July 28 as shown in FIG. 6C. The access point of the ISP is called and the mail data stored in the ISP servers is taken at 8:00, 8:45, 9:30, 10:15, 11:00, 11:45 and 12:30 on Saturday, July 29 as shown in FIG. 6D. No access point of the ISP is called and no mail data stored in the ISP servers is taken on Wednesday, July 26 and Sunday, July 30 as shown in FIG. 6E. When the calling inhibited flag is set to “1”, the automatic controller 25 recognizes this flag as a calling inhibited day. In contrast to this, when the calling inhibiting flag is set to “0”, the automatic controller 25 judges that it is not the calling inhibited day.

Thus, in accordance with the above operating control, data can be periodically fetched from the server in a different time zone per day of the week day or designated day. Further, it is possible to inhibit the fetching of data from the server in an arbitrary time zone in this time zone. Therefore, for example, when the facsimile apparatus in this embodiment is arranged within a company, the mail data can be automatically and precisely received.

In the above operating control, one time table number can be set as a day of the week table and a designated day table per day of the week and designated day. However, the invention is not limited to this, but plural time table numbers can be set. For example, when data is automatically fetched from the server during overtime work by utilizing setting of these plural time table numbers, it is intended that a calling time during this overtime work is stored in the calling time storage section 21, and is set as a second time table number in the day of the week table and designated day table. In accordance with such a construction, it is possible to cope with a case in which overtime work is suddenly decided.

In a setting method of the time table to the time storage section 21, a starting time, a terminating time and a time interval are inputted by using the operation key 8 and the dial key 9 in accordance with instructions of the display section 11, and a time for calling the access point of the ISP is automatically calculated and set from the inputted data. In another method, the starting time, the terminating time and the number of times are inputted by using the operation key 8 and the dial key 9 in accordance with the instructions of the display section 11, and the time for calling the access point of the ISP is automatically calculated and set from the inputted data. An operation of the facsimile apparatus at a time for automatically calculating the calling time from the starting time, the terminating time and the number of times will be explained with reference to a flow chart shown in FIG. 7.

When the control proceeds to a time setting mode based on operations of the operation key 8 and the dial key 9, and the starting time, the terminating time and the number of times are then inputted by operating the operation key 8 and the dial key 9 in accordance with the instructions of the display section 11 (step S11), the inputted number of times is compared with a preset maximum number of times (step S12). When the inputted number of times is smaller than the preset maximum number of times, the inputted starting time and terminating time are converted to minutes (step S13), and the starting minutes and the terminating minutes are compared with each other (step S14). For example, 9:30 is converted to “570”, and 17:00 is converted to “1020”.

When the terminating minutes are greater than the starting minutes, a value obtained by subtracting the starting minutes from the terminating minutes is divided by a value obtained by subtracting “1” from the number of times, and thus obtained value is set to a time interval (step S15). In contrast to this, when the terminating minutes are smaller than the starting minutes, a value obtained by subtracting the terminating minutes from the starting minutes is subtracted from “1440”, and a value obtained by this subtraction is divided by a value obtained by subtracting “1” from the number of times, and thus obtained value is set to a time interval (step S16). An automatic calling time obtained from the starting time, the terminating time, the time interval and the number of times is set to the time table (step S17). At this time, when a time zone for inhibiting the calling to the server is set, the calling time is set avoiding this inhibited time zone.

Accordingly, in accordance with the above operating control, an optimum time for calling the server can be automatically determined by inputting the starting time, the terminating time and the number of times. Therefore, communication cost for calling the server can be restrained to a desired amounted of fee by a user without requiring a complicated operation of the user.

When the facsimile apparatus can be connected to plural servers, setting data can be set for each of the servers. Thus, an access time can be set for server so that convenience can be improved.

In the above embodiment, the facsimile apparatus for fetching mail data stored in the server managed by the ISP by calling an access point of the ISP is exemplified and explained as a communication apparatus for fetching data stored in the server by periodically accessing the server in a predetermined time zone. However, the invention is not limited to a facsimile apparatus, but to communication apparatuses including a personal computer and a multimedia terminal utilizing an ISP, or a facsimile apparatus, a personal computer and a multimedia terminal connected to servers through a LAN.

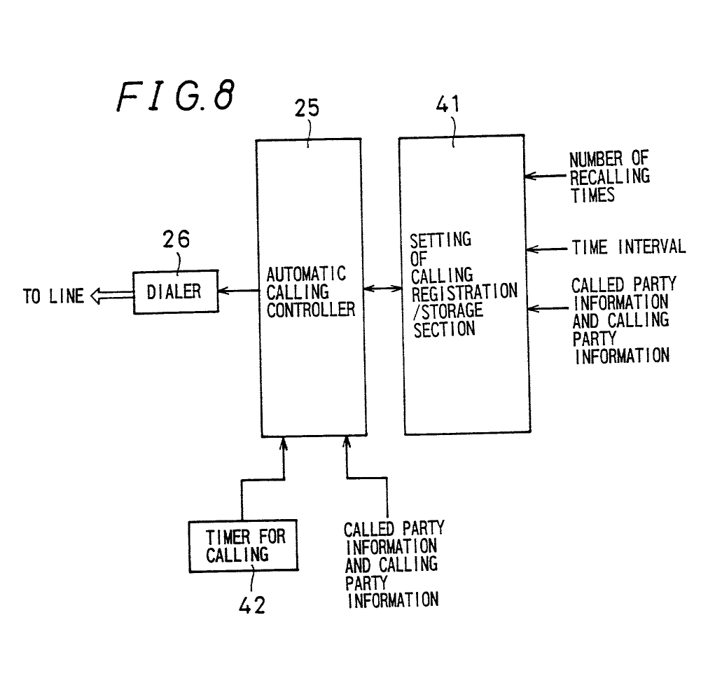

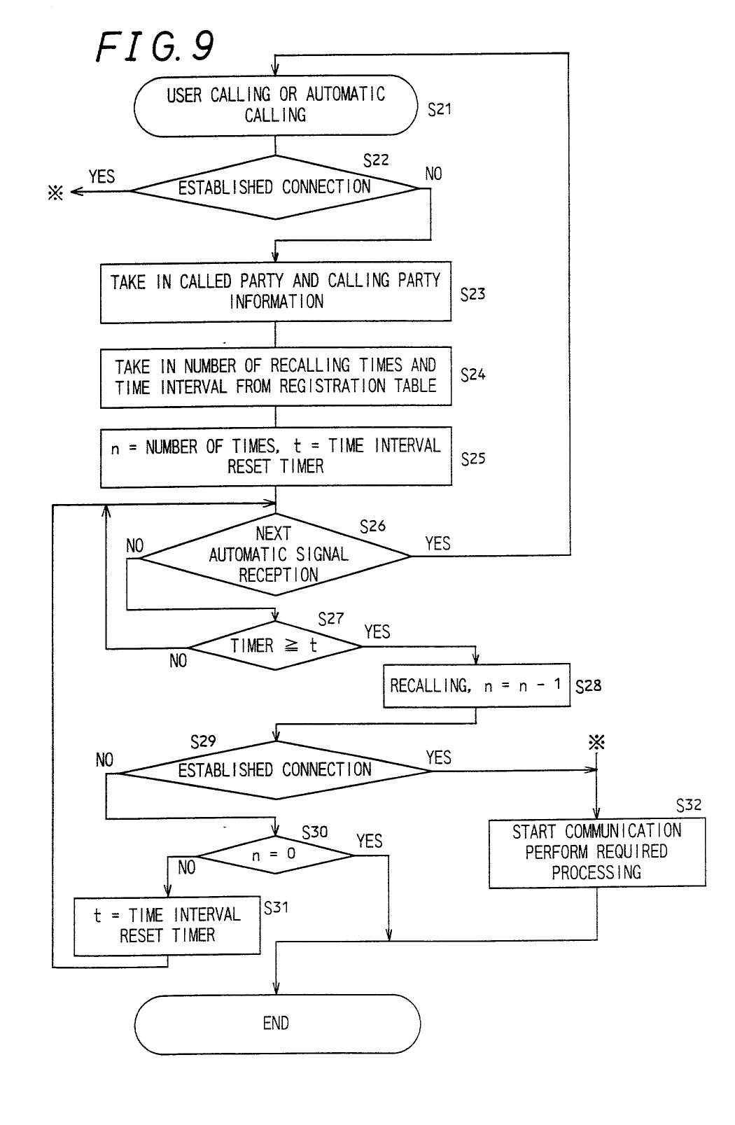

The operation of another facsimile apparatus connected to the Internet in this embodiment at a calling time will next be explained with reference to a functional block diagram shown in FIG. 8 and a flow chart shown in FIG. 9. A construction similar to that of the facsimile apparatus in this embodiment shown in FIG. 3 is partially omitted.

In FIG. 8, a section for registration/storage of setting of calling (hereinafter referred to as a setting of calling registration/storage section) 41 stores the number of recalling times and a time interval as a table per calling destination. In the case of mail, plural calling subscribers can be registered. Further, there is also a case in which plural DNS (Domain Name System) addresses and access points are designated for each of the calling subscribers. All of respective combinations correspond to calling destinations and calling source information, and the number of recalling times and the time interval are registered. In a registering method, it is automatically judged whether or not a calling destination is an access point of the ISP, and the number of recalling times and the time interval are automatically set such that the number of recalling times is increased and the time interval is shortened in the case of the access point of the ISP. In contrast to this, when it is not the access point of the ISP, the number of recalling times and the time interval may be automatically set such that the number of recalling times is reduced and the time interval is lengthened. Further, an inputting operation may be performed by using the operation key 8 and the dial key 9 in accordance with instructions of the display section 11.

Reference numerals 42, 25 and 26 respectively denote a timer for calling, an automatic calling controller and a dialer. The automatic calling controller 25 performs calling in accordance with the input of a calling destination and calling source information, and automatically performs recalling in accordance with contents of the setting of calling registration/storage section 41 using a time of the timer 42 for calling as a reference when disconnection is set by busyness, a connection failure, or the like, in this calling. The dialer 26 sends dial data to the public line network 1 in accordance with instructions from the automatic calling controller 25.

The setting of calling registration/storage section 41 is constructed so as to include the storage section 10. The timer 42 for calling and the automatic calling controller 25 are constructed so as to include the storage section 10 and the control section 14. The dialer 26 is constructed so as to include the network control section 2. A calling operation is controlled by the setting of calling registration/storage section 41, the timer 42 for calling, the automatic calling controller 25 and the dialer 26.

Registration data is stored in the setting of calling registration/storage section 41 by the dial key 9 as setting means, or the like. In the registration data, the number of recalling times, a time interval of recalling, calling destination information, calling source information, or the like, are preset by a user.

FIG. 9 is a flow chart showing operating control of a facsimile apparatus in another embodiment at a calling time. The control of the calling operation is started by the user or automatically based on the access time shown in the above description (step S21). The user's calling means a calling based on an arbitrary operation of the user, and the automatic calling means periodic calling based on preset time, interval data and calling destination data.

When this calling is achieved and connection is established, processing required to start communication is performed (step S32), and the calling operation is terminated. In contrast to this, when no calling is achieved and no connection is established (step S22), the automatic calling controller 25 takes-in a calling destination and calling source information (step S23), and fetches data required to set recalling from the setting of calling registration/storage section 41 based on the taken-in calling subscriber and calling source information (step S24). The automatic calling controller 25 then sets the number n of recalling times and a time interval t based on the data, and resets the timer 42 for calling, and starts a time measurement (step S25).

In the case of the normal facsimile transmission, for example, the calling is performed by one of dial, shortening dial and one touch dial of a destination number from the dial key 9. In the case of connection to the Internet, a calling subscriber inputs one of the partner destination number, one portion of DNS, and one portion of a name of the destination, and a list of partner destinations is displayed in the display section 11. The calling is performed by dialogically determining the partner destination from this list. A calling destination and a calling source can be specified from the information. Therefore, the information is taken into the automatic calling controller 25 as a calling destination and calling source information.

Thereafter, when the next automatic calling time has come before the value of the timer 42 for calling reaches a time t (step S26), the control of the calling operation in this automatic calling is started (step S21). In contrast to this, when the value of the timer 42 for calling has reached the time t before the next automatic calling time comes (step S27), recalling is performed and the number n of recalling times is reduced by one (step S28).

When this calling is achieved and connection is established (step S29), processing required to start communication is performed (step S32), and the calling operation is terminated. In contrast to this, when no calling is achieved and no connection is established (step S29), it is judged whether the number n of recalling times has reached zero or not (step S30). When it is judged that the number n of recalling times has reached zero, the calling operation is terminated. In contrast to this, when it is judged that the number n of recalling times has not reached zero, the timer 42 for calling is reset and the time measurement is started (step S31) . It is again judged whether the next automatic recalling time has come or not (step S26), and it is judged whether the value of the timer 42 for calling has reached the time t or not (step S27). Thereafter, operation control (steps S28 to S31) similar to that in the above case is executed.

Accordingly, in accordance with this embodiment, the number of recalling times and the time interval can be stored as a table per calling destination, and the recalling operation is controlled based on the number of recalling times and the time interval set based on this table. Therefore, when it is considered that the number of lines of the communication apparatus is normally one and the number of lines at an access point of the ISP is normally multiple and the calling destination is an access point of the ISP, the number of recalling times and the time interval can be preset such that the number of recalling times is increased and the time interval is shortened. Further, when no calling destination is not an access point of the ISP, the number of recalling times and the time interval can be preset such that the number of recalling times is reduced and the time interval is lengthened. A reconnection request in the case of being busy at the calling destination can be suitably made by such setting without requiring a complicated operation of a user.

In the above embodiment, when the next automatic calling time has come at a recalling operation time, the recalling operation is terminated and the next automatic calling is preferentially performed. However, the invention is not limited to this case, but the next automatic calling may be delayed, or the next automatic calling and the recalling operation may be shifted in a time series to be simultaneously performed.

In the above embodiment, the facsimile apparatus is exemplified and explained as a communication apparatus able to be connected to the Internet through the server connected to the public line network, but no communication apparatus is limited to the facsimile apparatus. It showed be understood that the invention can be also applied to an Internet telephone system, other multimedia communication apparatuses, or the like.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus for accessing a server connected through a network and fetching data stored in the server, comprising:
setting means for setting a time for accessing the server based on inputted starting time data, terminating time data, and number of times data or time interval data;
storage means for storing the time setting by the setting means on a weekly basis or daily basis; and
control means for determining the time of accessing the server based on setting data stored in the storage means and the present day of the week or date, and fetching data stored in the server by accessing the server at the determined time.

2. The communication apparatus of claim 1, wherein the storage means stores a time zone or date for inhibiting access to the server, and the control means makes no access to the server based on setting data stored in the storage means, in the access-inhibited time zone or date.

3. The communication apparatus of claim 1, wherein the storage means sets and stores the access time on a day of the week basis or date basis for plural servers, and the control means gets access on the basis of the setting data stored in the storage means to each of the plural servers.

4. The communication apparatus of claim 2, wherein the storage means sets and stores an access-inhibited time zone or date for each of plural servers, and the control means accesses each of the plural servers according to the setting data stored in the storage means.

5. A communication apparatus for accessing a server connected through a network and fetching data stored in the server comprising:
setting means for determining an access time to the server on the basis of inputted starting time data, terminating time data, and number of times data or time interval data;
storage means for storing the time set by the setting means and a time zone for inhibiting access to the server; and
control means for determining the access time to the server on the basis of setting data stored in the storage means, and fetching data stored in the server by accessing the server at the determined time, and getting in the access-inhibited time zone, no access to the server on the basis of the setting data stored in the storage means.

6. The communication apparatus of claim 5, wherein the storage means stores the access time and the access-inhibited time zone for each of plural servers, and the control means determines the access time to each of the plural servers on the basis of the setting data stored in the storage means.

7. A communication apparatus for accessing a server connected through a network and fetching data stored in the server comprising:
setting means for determining an access time to the server on the basis of inputted starting time data, terminating time data and number of times data;
storage means for storing the time determined by the setting means; and
control means for accessing the server at the time stored in the storage means and fetching data stored in the server,
wherein the setting means determines the time for accessing the server by avoiding any access-inhibited time zones to the server when the access-inhibited time zones have been inputted.

8. The communication apparatus of claim 7, wherein the setting means determines the access time to each server by avoiding each inhibiting time zone inputted for each of the plural servers, and the control means accesses each of the plural servers on the basis of the setting data stored in the storage means.

9. A communication apparatus able to be connected to the Internet through a server connected through a public line network comprising:
recalling means for repeating a connecting request to a desired calling destination when no connection to this calling destination can be performed; and
setting means for individually setting a repeating interval of the connection request by the recalling means depending on when the desired calling destination is a server or not.

10. The communication apparatus of claim 9, wherein the setting means sets the repeating interval of the connecting request by the recalling means for every individual server when plural connectable servers exist.

11. A communication apparatus able to be connected to the Internet through a server connected through a public line network comprising:
automatic receiving means for fetching data stored in the server by periodically performing connection to the server; and
recalling means for repeating a connection request to a desired calling destination when no connection to this calling destination can be performed,
wherein in a repeating state of the connecting request to the desired calling destination, the recalling means stops the repetition of the connecting request to the desired calling destination being executed when the automatic receiving means is fetching the data.
